(19) United States
(12) Patent Application Publication
(10) Pub. No.: US 2013/0133499 A1
(43) Pub. Date: May 30, 2013

(54) DEVICE FOR PROCESSING OR GENERATING BREAK LINES IN FLAT PRODUCTS

(71) Applicants: Hans-Peter Rohrer, Moehlin (CH); Claus Lautz, Orselina (CH); Hans Peter, Herznach (CH)

(72) Inventors: Hans-Peter Rohrer, Moehlin (CH); Claus Lautz, Orselina (CH); Hans Peter, Herznach (CH)

(73) Assignee: PANTEC AG, 6362 Stansstad (CH)

(21) Appl. No.: 13/816,113

(22) PCT Filed: Jun. 14, 2011
(86) PCT No.: PCT/EP2011/059816

§ 371 Date: Feb. 8, 2013

(30) Foreign Application Priority Data
Aug. 9, 2010 (DE) 10 2010 039 094.1
Nov. 15, 2010 (DE) 10 2010 043 895.2

(51) Int. Cl. B26D 7/08

(52) U.S. Cl. CPC B26D 7/086
USPC 83/646

(57) ABSTRACT

In a_device for processing flat products using a processing tool which processes the product between the tool and a counter-tool, the processing tool is supported by an ultrasonic sonotrode. The processing tool performs a processing movement together with an ultrasonic sonotrode, wherein the processing movement results in a partial separation of the flat product.

The invention relates to a device for processing or generating break lines in flat products using a processing tool, which processes the product between the processing tool and a counter tool.

For example, the packaging in the food, cosmetic and pharmaceutical industry often consists of laminates. The packaging must be placed in the desired shape when the containers are manufactured; to this end, the packaging must, inter alia, be processed, in particular separated. Processing should be done with little wear in order to protect the tools and workpieces. A typical composite film is composed of a base film, which may consist, for example, of polyamide (PA), polyester (PES), polyethylene terephthalate (PET), polypropylene (PP), polystyrene (PS), polyvinyl chloride (PVC), and an integrated barrier layer protecting against the penetration of oxygen, water, fats and UV radiation. Such a barrier layer may be, for example, ethylene vinyl alcohol (EVOH), a thermoplastic material or an aluminum foil. The film composite typically also includes a cover sheet made, for example, of PET, PP, or a composite, for example with aluminum foil. Other materials are aluminum, paper laminate, paper, corrugated paper and even fabric panels.

DE 103 59 036 B4 discloses a method for welding cups. DE 36 03 627 A1 and DE 201 14 860 U1 disclose a method for incorporating openings in containers. DE 10 2008 016 916 A1 discloses a device for cutting workpieces. DE 295 03 122 U1 discloses a sonotrode.

It is the object of the invention to further develop a processing device of the aforementioned type such that with the processing operation, the product attains an advantageous characteristic, wherein the processing operation can be carried with less wear or with a smaller applied force.

This object is attained according to the invention with a device of the aforementioned type in that the processing tool is supported by an ultrasonic sonotrode, and in that the processing tool, together with the ultrasonic sonotrode executes the processing movement, wherein the processing movement involves partial severing the flat product.

With the inventive device, the primary cutting movement of the processing tool, such as the punch or cutter, supplemented with an additional movement. This additional movement is produced by the ultrasonic sonotrode, to which the processing tool is attached. In this way, the products, also including laminates, can be reliably cut or punched with higher deformation capacity. This is done with the inventive device by applying reduced forces. The important advantage is that the flat product is additionally embrittled in the region in which it was processed. The flat product, which is for example a highly flexible film, can then be easily cut at the processed location by a deformation, for example, by bending. In conventionally processed films, the processed location is also deformed and does not break, because the weakened location is still flexible and elastic. Such a rated break point is impossible or at least difficult to break in two A preferred application of the invention is in knick-pack packaging, for example, for yogurt with cereal or in highly flexible, pliable films, such as transparent films.

A linear movement is regarded as advantageous processing movement of the processing tool. The ultrasound sonotrode performs an oscillating movement in a direction parallel to the working motion, and is superimposed on the working motion. The device of the invention thus performs a linear main movement superimposed on a linear oscillatory secondary motion in the cutting direction produced by ultrasound. Oscillation amplitudes from 5 μm to 20 μm are produced and transferred to the cutting edge.

The surface oscillations at the cutting edge serve to soften the laminate in the cutting zone and help to prevent a distortion of the material before the separation tear is introduced. An occasional separation of material particles from the laminate due to adhesive binding on the cutting tool (fiber formation), which frequently occurs in conventional cutting, can thus be prevented.

Further advantages, features and details of the invention will become apparent from the following description in which a particularly preferred embodiment is described in detail with reference to the drawing. Here, the features shown in the drawing and mentioned in the description and in the claims can each be essential for the invention either severally or in any combination.

In the drawings:

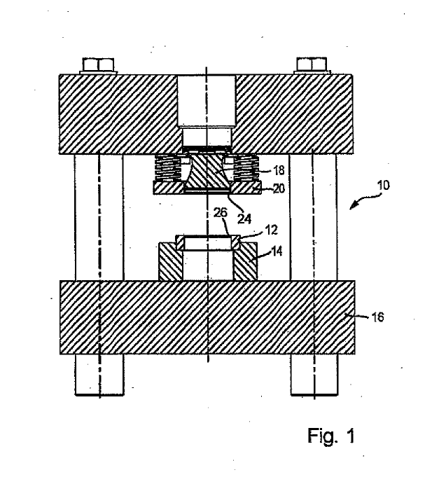

FIG. 1 shows a longitudinal section through a separating device in the open state, and

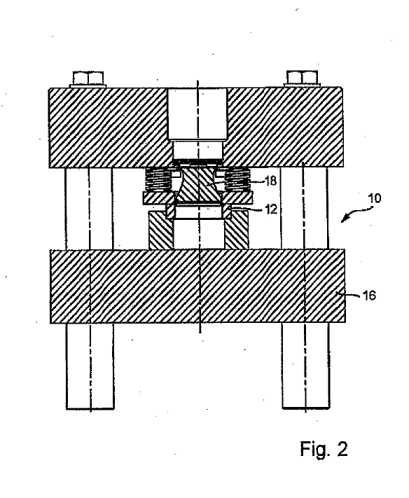

FIG. 2 shows a longitudinal section through the separating device in the closed state (shear cut).

The longitudinal section illustrated in the drawing shows a processing device, generally designated with 10, with a counter tool 12 (die), which is attached on a tool holder 14 and which can be moved vertically by a carriage 16. A working tool 18, which is surrounded by a hold-down device 20 and has at the bottom side a cutting edge 24, is located opposite the counter tool 12, The cutting edge 24 has spaced-apart cutting sections which can be used to produce a perforation cut. The dimensions of the cutting portions are selected such that the culling portions can move into the cutting contour 26 disposed in the counter tool 12 with a gap distance of a few 1/100 mm, as shown in FIG. 2. Here, the reciprocating movement of the carriage 16 is here superimposed on the ultrasonic movement of the processing tool 18. The material of the product to be processed (not shown) is thereby softened, thus substantially aiding with the cutting process. In addition, the cutting edges are rounded. Lands remain between the cuffing sections on product to be processed.

The processing tool 18 may also have a continuous cutting edge 24, with which the flat product, however, is separating only over a portion of the thickness. In both variants, the flat product is embrittled in the processing region, so that the processing location can then be easily broken apart by deformation.

The counter tool 12 may also be constructed with a closed surface, so that the processing tool 18 performs a crush cut. Here, the closing movement of the carriage 16 ends before the counter tool 12 contacts the processing tool 18.

1-10. (canceled)

11. A device for processing or generating break lines in flat products, comprising:
a processing tool,
an ultrasonic sonotrode supporting the processing tool,
a counter-tool facing the processing tool, wherein a flat product is processed between the processing tool and a counter-tool,
wherein the processing tool in conjunction with the ultrasonic sonotrode performs a processing movement causing partial severing of the flat product.

12. The device of claim 11, wherein the processing movement performs at least one operation selected from perforating and kiss-cutting the flat product.

13. The device of claim 11, wherein the processing movement of the processing tool is a linear movement.

14. The device of claim 11, wherein the ultrasonic sonotrode performs an oscillatory movement, with a direction of the oscillatory movement being parallel to the processing movement and superimposed on the processing movement.

15. The device of claim 14, wherein the oscillatory movement of the ultrasonic sonotrode has a stroke of 5 μm to 20 μm.

16. The device of claim 11, wherein power required for the processing movement is reduced by of up to 20% compared to a processing movement in absence of the ultrasonic sonotrode.

17. The device of claim 11, wherein the processing tool is a perforation knife configured to cut the flat product in sections, with lands remaining between separation locations.

18. The device of claim 17, wherein the processing tool reduces a height of the lands.

19. The device of claim 11, wherein the processing tool has a cutting edge, and reduces a height of the flat product.

20. The device of claim 11, wherein the ultrasonic sonotrode is a converter sonotrode.
